(19) United States
(12) Patent Application Publication
(10) Pub. No.: US 2006/0170213 A1
(43) Pub. Date: Aug. 3, 2006

(54) Methods and devices for horizontal directional drilling and other procedures

(76) Inventor: David A. Mittler, St. Louis, MO (US)

Correspondence Address: James B. Surber;Bryan Cave LLP, Suite 3600, 211 N. Broadway, St. Louis, MI, 63102, US

(21) Appl. No.: 11/036,560

(22) Filed: Jan. 14, 2005

(51) Int. Cl. F16L 25/00; F16L 35/00

(52) U.S. Cl. 285/328

(57) ABSTRACT

The present invention relates generally to horizontal directional drilling. More particularly, the invention provides certain pipe assemblies, pipe connectors, and methods which may be used in connection with horizontal directional drilling. In certain embodiments, the invention provides pipe connectors which may be used to mechanically interlock separate pipe segments, wherein the interlocked segments are capable of sustaining the bending moments and other forces that are experienced during horizontal directional drilling procedures.

### FIELD OF THE INVENTION

The present invention relates generally to horizontal directional drilling and other pipe installation procedures. More particularly, the invention provides certain devices, pipe assemblies, and methods which may be used in connection with horizontal directional drilling and other pipe installation procedures.

### BACKGROUND OF THE INVENTION

For years, underground pipes, which consist of (or encapsulate) water lines, sewer lines, oil lines, electrical cables, fiber optic lines, and others, have been installed using traditional pipe jacking, microtunneling, auger boring, pipe ramming, and related methods. Such installation methods, generally, advance the pipes through a trench or tunnel in the ground one segment at a time. The pipes are, typically, advanced by applying force to the rear of the pipe string, thereby causing the connected pipe segments to sustain, generally, compression-type forces. Such methods of installation, generally, involve minimal steering (and seek to advance the adjoined pipe segments in the straightest line possible).

In order to expedite the sequential attachment of such pipe segments to one another, certain connectors have been developed, which generally facilitate mechanical attachment (thereby reducing or eliminating the need for such segments to be welded together). Such mechanical connectors, however, were developed for use with traditional pipe jacking, microtunneling, auger boring, pipe ramming, and related methods. That is, such connectors were designed to withstand compression-type forces, but generally exhibit a limited capacity to sustain bending moments (i.e., such connectors may not withstand—and may break apart in response to—certain bending moments which are required to impart a change of direction on the combined pipe segments). Such bending moments are, generally, experienced during horizontal directional drilling procedures (HDD)—and other procedures which require installed pipes to turn or otherwise change direction.

The directionally controlled horizontal drilling process, for example, was developed in the United States and is commonly used for installing various pipes under natural or manmade obstacles, including pipes which consist of (or encapsulate) water lines, sewer lines, oil lines, electrical cables, fiber optic lines, and others. Such methods have revolutionized, among other things, complicated river crossings for pipelines which were initially conducted by conventional dredging methods or were rerouted through long distances and crossed over at a bridge location.

In many cases, the directional drilling operation is a two stage process. The first stage involves the drilling of a pilot hole, the dimensions of which may vary depending on the dimensions of the installed pipes, from one side of the obstacle to the other along the centerline of the proposed pipeline. The second stage involves enlarging the pilot hole to the desired diameter in order to accommodate the pipeline.

Once the pilot hole has been enlarged to the desired diameter, an appropriately configured pipe may be disposed therein. Similar to the methods described above, the pipe is preferably installed in segments. In addition, it is preferred that the pipe segments be mechanically attached to one another, thus reducing or eliminating the need for time-consuming welding steps. During HDD procedures, however, the adjoined pipe segments often encounter bending moments, pull-back loads (i.e., such pipe segments may be “pushed” and/or “pulled” through the pilot holes), and other shear forces. That is, such adjoined segments are subject to more than just compression-type forces.

In light of the foregoing, a demand exists for pipe assemblies, connectors, and methods which allow pipe segments to be adjoined mechanically (which reduce or eliminate the need for time-consuming welding procedures), wherein the adjoined pipe segments exhibit sufficient flexibility to pass through entry and exit curvatures (which may span an obstacle) during HDD or other applicable procedures.

### SUMMARY OF THE INVENTION

According to one embodiment of the present invention, a pipe connecting assembly is provided, which comprises (i) a first connector having a plurality of engaging elements, a male segment, and a female segment and (ii) a second connector comprising a plurality of engaging elements which are complementary to the engaging elements of the first connector, a male segment, and a female segment, wherein the length of each such connector is greater than 4.5 inches. In certain preferred embodiments, the length of each such connector is greater than 6.0 inches. Depending on the dimensions of the pipe, in certain embodiments, the length of each such connector may be greater than 8.0 inches or, still further, greater than 10.0 inches.

According to another embodiment of the present invention, a pipe connecting assembly is provided, which comprises first and second connectors, wherein each connector includes a plurality of engaging elements, a male segment, and a female segment. In such embodiments, the length of each engaging element is, preferably, at least 0.60 inches. Still further, the engaging elements, male segment, and female segment of the second connector are complementary to the engaging elements, male segment, and female segment of the first connector, wherein the first and second connectors may be mechanically interlocked. Preferably, the length of each such connector is at least 4.5 inches, or, depending on the dimensions of the pipe, may be greater than 6.0, 8.0, or 10.0 inches. In still further embodiments, and depending on the dimensions of the pipe, the total length of each engaging element may be greater than 0.80, 1.00, or 1.20 inches.

According to yet another embodiment of the present invention, methods for installing pipeline in a pilot hole for horizontal directional drilling purposes (or other applicable procedures) are provided. In certain embodiments, such methods comprise (a) placing a first connector of a first pipe segment in the proximity of a second connector of a second pipe segment, wherein (i) the first connector and the second connector each comprise a plurality of engaging elements, a male segment, and a female segment, (ii) the engaging elements, male segment, and female segment of the first connector are capable of interlocking with the engaging elements, male segment, and female segment of the second connector, and (iii) the length of each connector is greater than 4.5 inches; (b) attaching the first pipe segment to the second pipe segment by causing the engaging elements, male segment, and female segment of the first connector to interlock with the engaging elements, male segment, and female segment of the second connector; and (c) applying sufficient force to the attached first and second pipe segments to advance the segments forward. As described herein, depending on the overall dimensions of the pipe segment, in certain embodiments, the length of each connector may be greater than 6.0, 8.0, or 10.0 inches. Still further, depending on the overall dimensions of the pipe segment, in certain embodiments, the engaging elements of the connectors employed in such methods may span a total length of more than 0.80, 1.00, or 1.20 inches.

The above-mentioned and additional features of the present invention are further illustrated in the Detailed Description contained herein.

### BRIEF DESCRIPTION OF THE FIGURES

FIG. 1: A cross-sectional side view of a connector embodiment of the present invention, which shows an enlarged side view of an engaging element of such connector.

FIG. 2: Another cross-sectional side view of a connector embodiment of the present invention.

FIG. 3: A cross-sectional side view of male-type and female-type connector embodiments of the present invention, wherein the male-type and female-type connectors include engaging elements, male segments, and female segments which are capable of interlocking with one another as described herein.

FIG. 4A: A perspective view of a pipe segment which may incorporate certain embodiments of the present invention.

FIG. 4B: A cross-sectional front view of a pipe segment which may incorporate certain embodiments of the present invention.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

The present invention relates generally to horizontal directional drilling (and other procedures which require installed pipes to bend, turn, or otherwise change direction). More particularly, the invention provides certain pipe assemblies, pipe connectors, and methods which may be used, for example, in connection with horizontal directional drilling (HDD). In certain embodiments, the invention relates to pipe assemblies and pipe connectors, which enable a plurality of pipe segments comprising such connectors to be attached in series, and pushed or pulled through, for example, a pilot hole for horizontal directional drilling purposes. Preferably, the connectors are configured in accordance with the present invention, such that interlocked pipe segments comprising such connectors may sustain bending moments and tension stresses which are prevalent during, for example, HDD procedures.

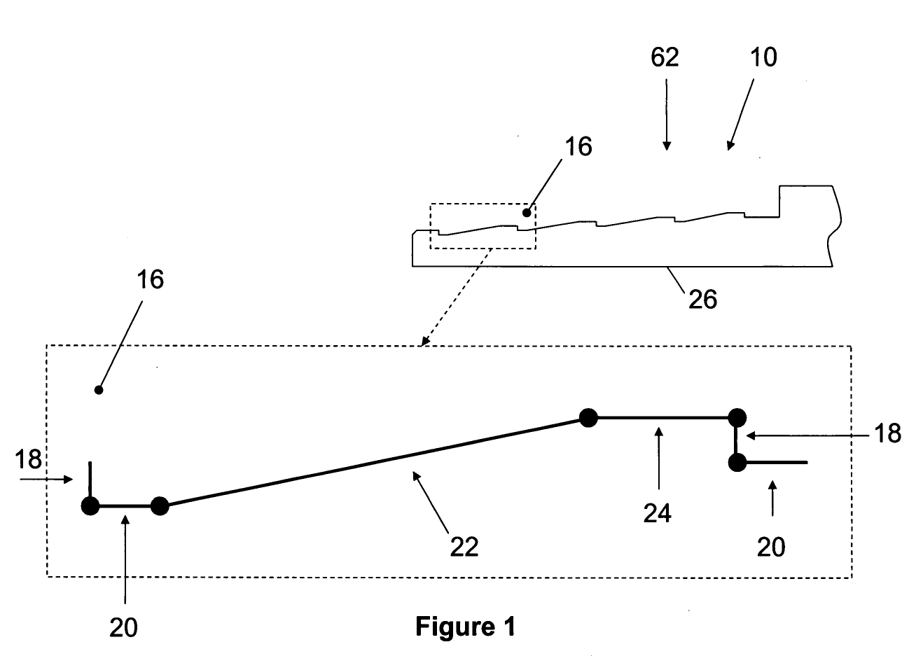

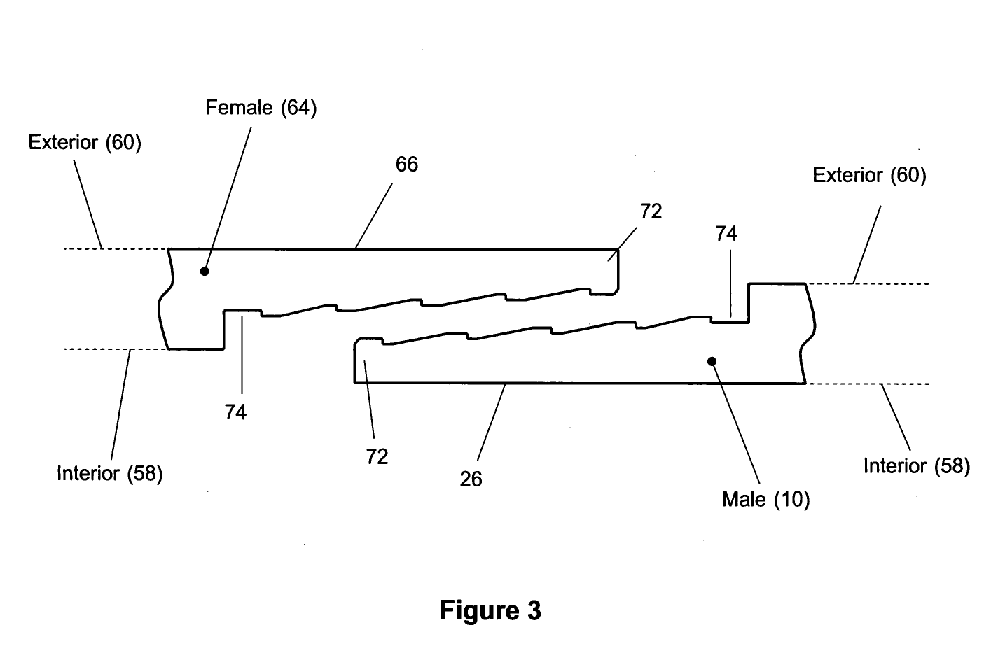

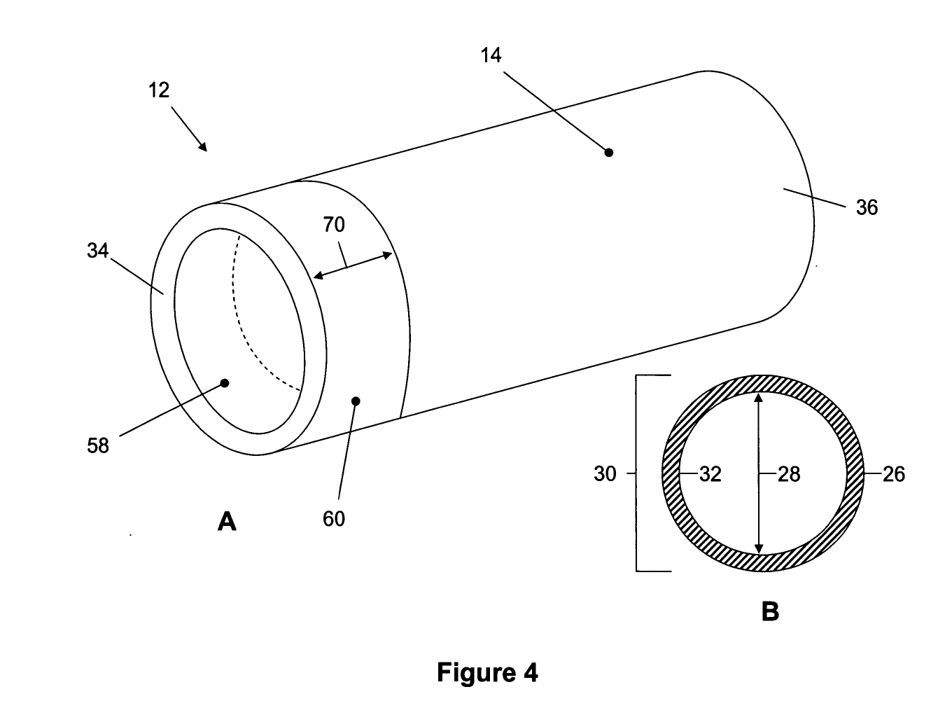

FIGS. 1, 2, and 3 show cross-sectional side views of such connector components 10,64. Referring to FIGS. 3 and 4, the connector components 10,64 of the present invention are, preferably, associated with the terminal ends 12,34 of pipe segments 14. Preferably, the connector components exhibit either male-type 10 or female-type 64 orientations. More particularly, the invention provides that male-type connector components 10 of the present invention reside on the exterior portion 60 of such pipe segments 14, whereas female-type connector components 64 of the present invention reside on the interior portion 58 of such pipe segments 14.

More specifically, the engaging portions 62 of such male-type connector components 10 face the outside (or exterior) of such pipe segments 14, whereas the engaging portions 62 of female-type connector components 64 face the inside (or interior) of such pipe segments 14. Referring to FIG. 3, such design allows a pipe segment 14 comprising a female-type connector 64 to receive and engage an appropriately configured male connector 10 associated with another pipe segment 14. In certain embodiments, each pipe segment 14 comprises one connector component at one of the terminal ends 12; whereas, in other embodiments, each pipe segment 14 comprises a connector component at both terminal ends. Still further, the invention contemplates that each pipe segment 14 may comprise (i) a male-type connector 10 at one terminal end and a female-type connector 64 at its other terminal end; (ii) male-type connectors 10 at both terminal ends; or (iii) female-type connectors 64 at both terminal ends..

The connector components 10,64 preferably comprise a plurality of engaging elements 16. The connector components 10,64 shown in FIGS. 1, 2, and 3 comprise four separate engaging elements 16. It should be appreciated, however, that more or less engaging elements 16 may be employed in each connector 10,64 in accordance with the present invention. For example, in certain embodiments, the connectors 10,64 may be designed to comprise one, two, three, five, six, seven, eight, or more appropriately configured engaging elements 16. The engaging elements 16 generally comprise a series of distinct surfaces. Referring to FIG. 1, for example, an enlarged view of an engaging element 16 is shown, which comprises four distinct surfaces (18, 20, 22, and 24).

As shown in FIG. 1 (which illustrates an example male-type connector 10), for example, such distinct surfaces may vary in length and orientation with respect to the relative plane of the interior surface 26 of the pipe segment 14. As should be understood, with respect to female-type connectors 64, such distinct surfaces may vary in length and orientation with respect to the relative plane of the exterior surface 66 of the pipe segment 14 (not shown in FIG. 1). More particularly, in certain embodiments (and referring, for example, to the male-type connector 10 shown in FIG. 1), the first surface 18 may be oriented approximately 90° (i.e., perpendicular) in relation to relative plane of the interior surface 26; the second surface 20 may be oriented approximately parallel to the interior surface 26; the third surface 22 is preferably oriented at a position which is no more than 45° from the relative plane of the interior surface 26; and the fourth surface 24 may be oriented approximately parallel to the interior surface 26.

In certain preferred embodiments, the third surface 22 is preferably oriented at a position which is no more than 30° from the relative plane of the interior surface 26. In still further embodiments, the third surface 22 is oriented at a position (relative to the plane of the interior surface 26) falling within a range selected from the group consisting of 45°-30°; 30°-20°; 20°-10°; and 10°-1°. Those of ordinary skill in the art will appreciate that the above specifications are provided for illustration purposes only, and that variations may be employed in accordance with the present invention. In addition, it should be understood that the above description applies equally to female-type connectors 64, wherein such lengths and orientations are in relation to the exterior surface 66 of such pipe segments 14.

As stated, the length of each distinct surface comprising the engaging elements 16 may also vary. Referring to FIG. 1, for example, surface 22 is, preferably, the longest surface among 18, 20, 22, and 24. The length of surfaces 18, 20, and 24 (relative to one another) are not particularly germane to the present invention. Rather, the lengths of such surfaces relative to one another may vary and, depending on the overall geometry of the pipe segment 14 (including its interior 28 and exterior 30 diameters), may exhibit different or similar lengths.

In certain preferred embodiments, and for purposes of illustration only, the invention provides that surface 18 may range from approximately 0.005-0.040 inches in length; surface 20 may range from 0.050-0.400 inches in length; surface 22 (relative to the plane of, for example, the interior surface 26) may range from 0.050-4.000 inches in length; and surface 24 may range from 0.050-0.400 inches in length. The exact length of the foregoing surfaces will, of course, vary depending on the actual interior 28 and exterior 30 diameters employed in the pipe segment 14 (as well as the thickness of the pipe segment 68). The foregoing specifications, for example, contemplate pipe segments 14 whose exterior diameter 30 ranges from 6.0 to 16.0 inches. Accordingly, the foregoing specifications may increase, for example, as the interior 28 and/or exterior 30 diameters of the pipe segment 14 increase or, alternatively, may decrease, for example, as the interior 28 and/or exterior 30 diameters of the pipe segment 14 decreases.

Similar to the relative orientation of each such distinct surface of the engaging elements 16, those of ordinary skill in the art will appreciate that the invention contemplates that the specific lengths of such distinct surfaces may be adjusted and deviate from those shown and/or described herein. Still further, the invention provides that more or less distinct surfaces may be employed in each engaging element 16, such as, for example, 3, 5, 6, 7, or 8 or more distinct surfaces may be employed therein.

In certain embodiments, the general position of each engaging element 16 relative to the planes of the interior surface 26 (for male-type connectors 10) or exterior surface 66(for female-type connectors 64) of the pipe segments 14 may vary within each connector component 10,64. In such embodiments, for example, the engaging elements 16 comprising each connector component 10 (male-type) may gradually increase in thickness (relative to, for example, the plane of the interior surface 26 of the pipe segment 14) from the terminal portion 34 of the pipe segment 14 to its general proximal (or interior) portion 36. Similarly, for example, the engaging elements 16 comprising each connector component 64 (female-type) may gradually increase in thickness (relative to, for example, the plane of the exterior surface 66 of the pipe segment 14) from the terminal portion 34 of the pipe segment 14 to its general proximal (or interior) portion 36.

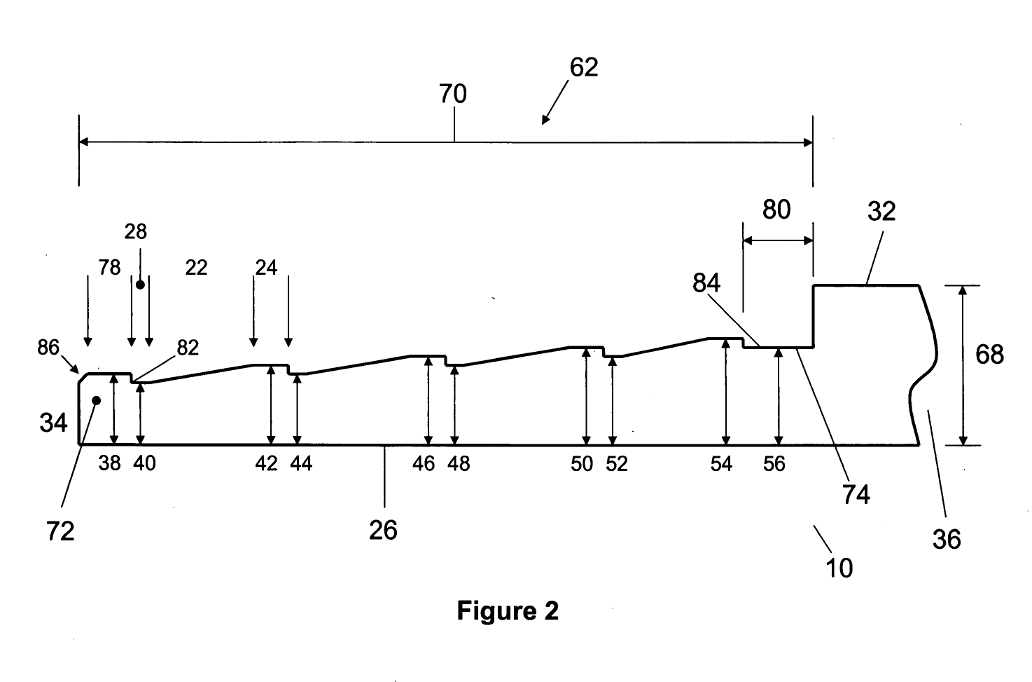

Referring to FIG. 2, for example, the engaging elements 16 within the connector component 10 shown therein gradually increase in thickness (relative to the plane of the interior surface 26 of the pipe segment 14) from the terminal (or distal) portion 34 of the pipe segment 14 to its interior (or proximal) portion 36. More specifically, referring to surfaces 20 and 24 of each such engaging element 16 within the illustrated connector 10, it is shown that such surfaces gradually increase in thickness (relative to the plane of the interior surface 26 of the pipe segment 14) from 40 to 42,44; from 42,44 to 46,48; from 46,48 to 50,52; and from 50,52 to 54. The invention provides that such increase in thickness among the engaging elements 16 may be gradual and consistent or, alternatively, may be irregular (i.e., the change in thickness among engaging elements 16 of a connector may be consistent or variable). In addition to the foregoing embodiments, the invention further encompasses connector components 10,64, wherein the position of each engaging element 16 (relative to the planes of the interior or exterior surface 26,66 of the pipe segment 14, respectively) does not vary (or does not significantly vary) within each such connector component 10,64.

As shown in FIG. 3, the connectors 10,64 and engaging elements 16 of such connectors are, preferably, configured such that the connectors may be mechanically engaged. More specifically, for example, the configuration and surface dimensions of the engaging elements 16 of the male-type connectors 10 are, preferably, complementary to the engaging elements 16 of the female-type connectors 64. Still more specifically (as shown in FIG. 3), for example, the invention contemplates that when such male-type 10 and female-type 64 connectors are engaged, surfaces 20 (of the engaging elements 16) of the male-type connector 10 adjoin surfaces 24(of the engaging elements 16) of the female-type connector 64. Of course, in such engagement, surfaces 24 of the male-type connector 10 would, preferably, adjoin surfaces 20 of the female-type connector 64. Still further, for example, the invention contemplates that when such male-type 10 and female-type 64 connectors are engaged, surfaces 18 and 22 of the male-type connector 10 adjoin surfaces 18 and 22 of the female-type connector 64.

In addition, the invention provides that such connectors 10,64 are preferably configured such that when a male-type connector 10 of a first pipe segment 14 engages a female-type connector 64 of a second pipe segment 14, the exterior and interior surfaces 66,26 of the combined pipe segments 14 are relatively smooth at the junction point. As shown in FIG. 3 (and described above), for example, the connectors 10,64 may generally increase in thickness from the terminal end 34 of each pipe segment 14 to the proximal end 36. In such embodiments, as shown in FIGS. 3 and 4, because the male-type connectors 10 reside on the exterior surface 60 (i.e., the engaging portion 62 of such connectors face the exterior of the pipe segment) and the female-type connectors 64 reside on the interior surface 58 (i.e., the engaging portion 62 of such connectors face the interior of the pipe segment), such increases in thickness of the male- and female-type connectors 10,64 (from terminal 34 to proximal 36 portions) are complementary to one another, which facilitates a preferably tight mechanical engagement between such connectors 10 and 64. Alternatively, as described herein, the approximate thickness of such connectors from terminal 34 to proximal portions 36 may be substantially consistent, which also encourages a preferably tight mechanical engagement.

Still further, the invention provides that the general thickness (which may generally be measured by, for example, the most proximal engaging element 16, such as illustrated by surface 54 in FIG. 2) of the male-type connector 10 may be different or substantially the same as the general thickness of the female-type connector 64. Importantly, however, the surface dimensions of the engaging elements 16 which comprise such connectors (including the length and orientations of the surfaces which comprise each engaging element 16) are complementary to one another (as described herein), allowing such connectors to be mechanically engaged. In any of the foregoing embodiments, the invention provides that the engaged pipe segments 14 preferably exhibit a relatively smooth junction point. Thus, for example, if the general thickness of the engaging portion 62 of the male-type connector 10 is greater than the general thickness of the engaging portion 62 of the female-type connector 64, the dimensions and general thickness of such engaging portions 62 for both connector types should be configured such that the total thickness of the pipe segment 68 does not significantly change across the junction point—both at the exterior 66 and interior 26 surfaces of such junction point. That is, the dimensions and general thickness of such connectors and, specifically, engaging portions 62 should be configured such that the interior 26,58 and exterior 66,60 surfaces of pipe segments 14(when mechanically engaged) are relatively smooth across the junction point (i.e., the position within adjoined pipe segments 14 at which the engaging portions 62 of separate connectors 10 and 64meet and engage).

The total length 70 of the connectors 10,64 described herein is, preferably, sufficient to withstand the bending moments and shear forces which typically accompany, for example, HDD procedures. More particularly, the invention provides that increasing the total length 70 of the connectors 10,64 described herein (in comparison to other connectors known in art and used, for example, with more conventional microtunneling procedures) distributes such bending moments and shear forces across a greater area, thereby providing such pipe segments 14 employing such connectors 10,64 with a greater capacity to withstand such forces (without breaking apart).

Those of ordinary skill in the art will appreciate that the actual length 70 of such connectors 10,64 will depend on the overall geometry of the corresponding pipe segment 14, such as, for example, the exterior diameter 30, interior diameter 28, and the thickness of the pipe wall or segment 68. For purposes of illustration only, however, the invention provides that pipe segments 14 having an exterior diameter 30 ranging from 6.0-16.0 inches; an interior diameter 28 ranging from 5.0-15.0 inches; and pipe segment thickness 68 ranging from 0.300 to 0.500 inches, preferably, employ connectors 10,64 having a total length 70 of more than 4.5 inches, or more preferably at least 5.0 inches, or still more preferably at least 6.0 inches, or, in certain embodiments, at least 9.0 inches. As described herein and shown further in the Examples below, the exact preferred dimensions and length 70 of the connectors 10,64 will depend on the specific exterior diameter 30, interior diameter 28, and the thickness of the pipe wall 68.

In addition to the engaging elements 16 described above, the connectors 10,64 described herein, preferably, comprise at least one male segment 72 and at least one female segment 74. More specifically, the invention provides that both male- and female-type connectors 10,64 are, preferably, equipped with at least one male segment 72 and at least one female segment 74. The male and female segments are preferably configured such that the female segment 74 of a first connector may receive and engage the male segment 72 of a second connector, such that the corresponding connectors are capable of being mechanically attached (i.e., interlocked). According to certain embodiments, providing both male- and female-type connectors 10,64 with male and female segments 72,74 facilitates the desired mechanical interlocking between such connectors, as shown in FIG. 3. Preferably, providing both male- and female-type connectors 10,64 with male and female segments 72,74 allows the pipe segments 14 of the present invention to sustain the bending moments and other forces which are experienced during, for example, HDD procedures.

Referring to FIG. 2, the male segment 72 generally consists of a small protrusion 82 near the terminal end 34 of the connector 10(or terminal end 34 of a female-type connector 64, as shown in FIG. 3). In certain preferred embodiments, for example, the male segment 72 is substantially contiguous with the engaging element 16 near the terminal end 34 of the connector. In FIG. 2, for example, the male segment 72 is contiguous with surface 38 of the most terminal engaging element 16. In other embodiments, however, the male segment 72 may not be substantially contiguous with the engaging element 16 near the terminal end 34 of the connector.

The female segment 74 preferably consists of a cavity 84 near the proximal portion 36 of the connectors 10,64. Preferably, the depth of the cavity 84 is similar to the relative height of the protrusion 82 of the male segment 72. In such embodiments, the cavity 84 of the female segment 74 is capable of receiving the protrusion 82 of the male segment 72. Still further, the approximate length 78 of the male segment 72 is preferably configured to be received by the female segment 74. More specifically, in certain preferred embodiments, the invention provides that the length 80 of the female segment 74 is substantially similar to the length 78 of the male segment 72. In still other preferred embodiments, the length 80 of the female segment 74 is slightly more than the length 78 of the male segment 72. Such configurations encourage a preferably tight mechanical engagement between male- and female-type connectors 10,64.

In addition, referring to FIG. 2, the invention provides that, in certain embodiments, the connectors 10,64 include a chamfer 86 on the terminal portion of the male segment 72. The dimensions of such chamfer 86 are not particularly germane to the present invention and, of course, will depend on the overall geometry of the connector 10,64; male segment 72; female segment 74; and pipe segment 14. The invention provides, however, that chamfers 86 of approximately 1/16 inches in length may function well. The general purpose of the chamfer 86 is to facilitate the male segment 72 of a connector engaging and being received by the female segment 74 of another connector.

The pipe segments and connectors described herein may be constructed using any suitable material known in the art (currently existing or discovered hereafter). The invention provides, for example, that the pipe segments and connectors may be constructed of carbon steel, stainless steel, variations thereof, and/or other appropriate material. In certain embodiments, the male- and female-type 10,64 connectors described herein may be constructed apart from the body of the pipe segment, wherein such connectors may be subsequently attached to the pipe segments using any suitable means, such as welding procedures. Preferably, in such embodiments, the connectors are attached (or welded) to the pipe segments in a welding shop or other production facility (i.e., it is not necessary for the connectors to be attached to the pipe segment at the site where, for example, HDD procedures take place). In certain other embodiments, the male- and female-type connectors 10,64 described herein may be integrally formed with the terminal ends of the pipe segments, i.e., such connectors may be “machined” into the terminal ends of such pipe segments.

Furthermore, the invention contemplates that additional procedures, compositions, and devices may be applied to the connectors described herein to facilitate a desirable tight interlocking (or seal) between pipe segments. For example, in certain preferred embodiments, the invention provides that silicone-based sealants may be applied to the engaging portions 62 of the connectors 10,64 prior to being mechanically interlocked. In such embodiments, any sealant composition known in the art may be employed, such as, for example, liquid silicone-based sealants. In such embodiments, the silicone-based sealant, for example, further provides the engaging portions 62 with a lubricant to facilitate interlocking between male- and female-type connectors 10,64, which subsequently “cures” to encourage a tight seal between such connectors 10,64.

In such embodiments, the engaging portions 62 of the connectors 10,64 may optionally be configured to receive excess sealant. For example, the volume of the female segments 74 (or cavity therein 84 ) employed in such connectors may be slightly greater than the relative volume of corresponding male segments 72, such that excess sealant may be retained in any remaining space within the female segment 74 after the male segment 72 is disposed therein. In addition, it is contemplated that grooves, dimples, or ridges may be provided to the male segment 72, female segment 74, and/or engaging elements 16 to receive such excess sealant. Still further, the invention provides that rubber based gaskets may be provided to the engaging portions 62of the connectors 10,64 prior to being mechanically interlocked. The means by which such gaskets may be used in such embodiments are well known to those of ordinary skill in the art.

In light of the foregoing description, it is contemplated that one embodiment of the present invention may include a pipe connecting assembly comprising (i) a male-type connector 10 having a plurality of engaging elements 16, a male segment 72, and a female segment 74 and (ii) a female-type connector 64 comprising a plurality of engaging elements 16 which are complementary to the engaging elements 16 of the male-type connector 10, a male segment 72, and a female segment 74, wherein the total length of each such connector (male- and female-type) is greater than 4.5 inches. In certain preferred embodiments, the total length of each such connector is greater than 5.0 inches. Depending on the dimensions of the pipe segment 14(including the outer diameter 30, inner diameter 28, and pipe segment thickness 68 ), in certain embodiments, the length of each such connector may be greater than 6.0, or 8.0 inches or, still further, greater than 10.0 inches.

In addition, it is contemplated that another embodiment of the present invention may consist of a pipe connecting assembly which comprises a male-type connector 10 and female-type connector 64, wherein each such connector includes a plurality of engaging elements 16, a male segment 72, and a female segment 74. In such embodiments, the total length of each such engaging element 16 is, preferably, at least 0.60 inches or, more preferably, at least 0.80 inches or, still more preferably, at least 1.00 inches. Still further, the engaging elements 16, male segment 72, and female segment 74 of the male-type connector 10, for example, are complementary to the engaging elements 16, male segment 72, and female segment 74 of the female-type connector 64, wherein the male- and female-type connectors may be mechanically interlocked. Preferably, the length of each such connector is at least 4.5 inches, or, depending on the dimensions of the pipe segment 14(as describe herein), may be greater than 6.0, 8.0, or 10.0 inches.

The invention provides that pipe segments 14 comprising the connector components 10,64 described herein may be used in, for example, horizontal direction drilling procedures, and are capable of withstanding the bending moments and stress forces which generally accompany such procedures. Accordingly, further embodiments of the present invention include methods for installing pipeline in a pilot hole, wherein such pipeline may undergo bending moments or other shear forces during or after installation.

In certain embodiments, such methods comprise (a) placing a male-type connector 10 of a first pipe segment 14 in the proximity of a female-type connector 64of a second pipe segment 14, wherein (i) the male-type connector 10 and female-type connector 64 each comprise a plurality of engaging elements 16, a male segment 72, and a female segment 74, (ii) the engaging elements 16, male segment 72, and female segment 74 of the male-type connector 10 are capable of engaging and interlocking with the engaging elements 16, male segment 72, and female segment 74 of the female-type connector 64(as described herein), and (iii) the length of each such connector is greater than 4.5 inches; (b) attaching the first pipe segment 14(comprising the male-type connector 10 ) to the other pipe segment 14(comprising the female-type connector 64 ) by causing the engaging elements 16, male segment 72, and female segment 74 of the male-type connector 10 to interlock with the engaging elements 16, male segment 72, and female segment 74 of the female-type connector 64; and (c) applying sufficient force to the adjoined and interlocked first and second pipe segments to advance the combined segments forward through, for example, the pilot hole. As described herein, depending on the overall dimensions of the pipe segment 14, in certain embodiments, the length of each connector 10,64 may be greater than 4.5, 6.0, 8.0, or 10.0 inches. Still further, depending on the overall dimensions of the pipe segment 14, in certain embodiments, the engaging elements 16 of the connectors employed in such methods may span a total length of more than 0.60, 0.80, 1.00, or 1.20 inches.

The following Examples are included to demonstrate certain embodiments of the invention. It should be appreciated by those skilled in the art that the embodiments disclosed in the Examples that follow represent those discovered by the inventor to function well in the practice of the invention, and thus, may be considered to constitute preferred modes for its practice. However, those of ordinary skill in the art should, in light of the present disclosure, appreciate that many changes may be made in the specific embodiments that are disclosed and still obtain a like or similar result without departing from the spirit and scope of the invention.

### EXAMPLES

For purposes of illustration only, certain preferred embodiments of the connector components are contemplated and disclosed below, wherein each connector includes four engaging elements 16. The following description of such preferred embodiments makes reference to FIGS. 1-4, such that the disclosed dimensions may be easily understood. While FIGS. 1 and 2 show only a male-type connector 10, it should be appreciated that the dimensions set forth below (as described in relation to the connectors shown in such Figures) apply equally to corresponding portions of female-type connectors 64.

Referring to FIGS. 1 and 2, the engaging elements 16 of the following connector components gradually increase in thickness as described above. More specifically, the respective surfaces which comprise each engaging element 16 increase in thickness relative to one another—from the terminal 34 to proximal 36 ends of such connectors. In addition, as shown, both the male-type and female-type connectors 10,64 of the following embodiments include at least one male 72 and at least one female 74 segment.

### Example 1

The table below sets forth the dimensions of one embodiment of the present invention. Specifically, the embodiment disclosed below exhibits, among other things, a pipe segment 14 having an outer diameter of 6.625 inches; a pipe segment thickness 68 of 0.432 inches; a total connector length of 6.010 inches; and four engaging elements of such connectors each having a total length of 1.390 inches. Additional dimensions are specified in the following table:

| Male-Type Connector | Figures | Inches | Female-Type Connector | Figures | Inches |
|---|---|---|---|---|---|
| Outer Diameter | 30 | 6.625 | Outer Diameter | 30 | 6.625 |
| Inner Diameter | 28 | 5.761 | Inner Diameter | 28 | 5.761 |
| Pipe Segment Thickness | 68 | 0.432 | Pipe Segment Thickness | 68 | 0.432 |
| Total Connector Length | 70 | 6.010 | Total Connector Length | 70 | 6.010 |
| Engaging Element Length | | | Engaging Element Length | | |
| Surface | 18 | 0.020 | Surface | 18 | 0.020 |
| Surface | 20 | 0.145 | Surface | 20 | 0.145 |
| Surface | 22 | 1.120 | Surface | 22 | 1.120 |
| Surface | 24 | 0.125 | Surface | 24 | 0.125 |
| Engaging Element Thickness | | | Engaging Element Thickness | | |
| Surface | 40 | 0.210 | Surface | 40 | 0.177 |
| Surface | 42 | 0.235 | Surface | 42 | 0.202 |
| Surface | 44 | 0.215 | Surface | 44 | 0.182 |
| Surface | 46 | 0.240 | Surface | 46 | 0.207 |
| Surface | 48 | 0.220 | Surface | 48 | 0.187 |
| Surface | 50 | 0.245 | Surface | 50 | 0.212 |
| Surface | 52 | 0.225 | Surface | 52 | 0.192 |
| Surface | 54 | 0.250 | Surface | 54 | 0.217 |
| Male Segment Protrusion Height | 82 | 0.020 | Male Segment Protrusion Height | 82 | 0.020 |
| Male Segment Thickness | 38 | 0.230 | Male Segment Thickness | 38 | 0.197 |
| Male Segment Length | 78 | 0.220 | Male Segment Length | 78 | 0.210 |
| Female Segment Cavity Depth | 84 | 0.020 | Female Segment Cavity Depth | 84 | 0.020 |
| Female Segment Thickness | 56 | 0.230 | Female Segment Thickness | 56 | 0.197 |
| Female Segment Length | 80 | 0.230 | Female Segment Length | 80 | 0.240 |

### Example 2

The table below sets forth the dimensions of a second preferred embodiment of the present invention. Specifically, the embodiment disclosed below exhibits, among other things, a pipe segment 14 having an outer diameter of 8.625 inches; a pipe segment thickness 68 of 0.322 inches; a total connector length of 6.010 inches; and four engaging elements of such connectors each having a total length of 1.390 inches. Additional dimensions are specified in the following table:

| Male-Type Connector | Figures | Inches | Female-Type Connector | Figures | Inches |
|---|---|---|---|---|---|
| Outer Diameter | 30 | 8.625 | Outer Diameter | 30 | 8.625 |
| Inner Diameter | 28 | 7.981 | Inner Diameter | 28 | 7.981 |
| Pipe Segment Thickness | 68 | 0.322 | Pipe Segment Thickness | 68 | 0.322 |
| Total Connector Length | 70 | 6.010 | Total Connector Length | 70 | 6.010 |
| Engaging Element Length | | | Engaging Element Length | | |
| Surface | 18 | 0.020 | Surface | 18 | 0.020 |
| Surface | 20 | 0.145 | Surface | 20 | 0.145 |
| Surface | 22 | 1.120 | Surface | 22 | 1.120 |
| Surface | 24 | 0.125 | Surface | 24 | 0.125 |
| Engaging Element Thickness | | | Engaging Element Thickness | | |
| Surface | 40 | 0.138 | Surface | 40 | 0.139 |
| Surface | 42 | 0.163 | Surface | 42 | 0.164 |
| Surface | 44 | 0.143 | Surface | 44 | 0.144 |
| Surface | 46 | 0.168 | Surface | 46 | 0.169 |
| Surface | 48 | 0.148 | Surface | 48 | 0.149 |
| Surface | 50 | 0.173 | Surface | 50 | 0.174 |
| Surface | 52 | 0.153 | Surface | 52 | 0.154 |
| Surface | 54 | 0.178 | Surface | 54 | 0.179 |
| Male Segment Protrusion Height | 82 | 0.020 | Male Segment Protrusion Height | 82 | 0.020 |
| Male Segment Thickness | 38 | 0.158 | Male Segment Thickness | 38 | 0.159 |
| Male Segment Length | 78 | 0.220 | Male Segment Length | 78 | 0.210 |
| Female Segment Cavity Depth | 84 | 0.020 | Female Segment Cavity Depth | 84 | 0.020 |
| Female Segment Thickness | 56 | 0.158 | Female Segment Thickness | 56 | 0.159 |
| Female Segment Length | 80 | 0.230 | Female Segment Length | 80 | 0.240 |

### Example 3

The table below sets forth the dimensions of a third preferred embodiment of the present invention. Specifically, the embodiment disclosed below exhibits, among other things, a pipe segment 14 having an outer diameter of 8.625 inches; a pipe segment thickness 68 of 0.500 inches; a total connector length of 6.010 inches; and four engaging elements of such connectors each having a total length of 1.390 inches. Additional dimensions are specified in the following table:

| Male-Type Connector | Figures | Inches | Female-Type Connector | Figures | Inches |
|---|---|---|---|---|---|
| Outer Diameter | 30 | 8.625 | Outer Diameter | 30 | 8.625 |
| Inner Diameter | 28 | 7.625 | Inner Diameter | 28 | 7.625 |
| Pipe Segment Thickness | 68 | 0.500 | Pipe Segment Thickness | 68 | 0.500 |
| Total Connector Length | 70 | 6.010 | Total Connector Length | 70 | 6.010 |
| Engaging Element Length | | | Engaging Element Length | | |
| Surface | 18 | 0.020 | Surface | 18 | 0.020 |
| Surface | 20 | 0.145 | Surface | 20 | 0.145 |
| Surface | 22 | 1.120 | Surface | 22 | 1.120 |
| Surface | 24 | 0.125 | Surface | 24 | 0.125 |
| Engaging Element Thickness | | | Engaging Element Thickness | | |
| Surface | 40 | 0.227 | Surface | 40 | 0.228 |
| Surface | 42 | 0.252 | Surface | 42 | 0.253 |
| Surface | 44 | 0.232 | Surface | 44 | 0.233 |
| Surface | 46 | 0.257 | Surface | 46 | 0.258 |
| Surface | 48 | 0.237 | Surface | 48 | 0.238 |
| Surface | 50 | 0.262 | Surface | 50 | 0.263 |
| Surface | 52 | 0.242 | Surface | 52 | 0.243 |
| Surface | 54 | 0.267 | Surface | 54 | 0.268 |
| Male Segment Protrusion Height | 82 | 0.020 | Male Segment Protrusion Height | 82 | 0.020 |
| Male Segment Thickness | 38 | 0.247 | Male Segment Thickness | 38 | 0.248 |
| Male Segment Length | 78 | 0.220 | Male Segment Length | 78 | 0.210 |
| Female Segment Cavity Depth | 84 | 0.020 | Female Segment Cavity Depth | 84 | 0.020 |
| Female Segment Thickness | 56 | 0.247 | Female Segment Thickness | 56 | 0.248 |
| Female Segment Length | 80 | 0.230 | Female Segment Length | 80 | 0.240 |

### Example 4

The table below sets forth the dimensions of a fourth preferred embodiment of the present invention. Specifically, the embodiment disclosed below exhibits, among other things, a pipe segment 14 having an outer diameter of 16.000 inches; a pipe segment thickness 68 of 0.500 inches; a total connector length of 10.070 inches; and four engaging elements of such connectors each having a total length of 2.350 inches. Additional dimensions are specified in the following table:

| Male-Type Connector | Figures | Inches | Female-Type Connector | Figures | Inches |
|---|---|---|---|---|---|
| Outer Diameter | 30 | 16.000 | Outer Diameter | 30 | 16.000 |
| Inner Diameter | 28 | 15.000 | Inner Diameter | 28 | 15.000 |
| Pipe Segment Thickness | 68 | 0.500 | Pipe Segment Thickness | 68 | 0.500 |
| Total Connector Length | 70 | 10.070 | Total Connector Length | 70 | 10.070 |
| Engaging Element Length | | | Engaging Element Length | | |
| Surface | 18 | 0.020 | Surface | 18 | 0.020 |
| Surface | 20 | 0.195 | Surface | 20 | 0.195 |
| Surface | 22 | 1.980 | Surface | 22 | 1.980 |
| Surface | 24 | 0.175 | Surface | 24 | 0.175 |
| Engaging Element Thickness | | | Engaging Element Thickness | | |
| Surface | 40 | 0.226 | Surface | 40 | 0.229 |
| Surface | 42 | 0.251 | Surface | 42 | 0.254 |
| Surface | 44 | 0.231 | Surface | 44 | 0.234 |
| Surface | 46 | 0.256 | Surface | 46 | 0.259 |
| Surface | 48 | 0.236 | Surface | 48 | 0.239 |
| Surface | 50 | 0.261 | Surface | 50 | 0.264 |
| Surface | 52 | 0.241 | Surface | 52 | 0.244 |
| Surface | 54 | 0.266 | Surface | 54 | 0.269 |
| Male Segment Protrusion Height | 82 | 0.020 | Male Segment Protrusion Height | 82 | 0.020 |
| Male Segment Thickness | 38 | 0.246 | Male Segment Thickness | 38 | 0.249 |
| Male Segment Length | 78 | 0.350 | Male Segment Length | 78 | 0.300 |
| Female Segment Cavity Depth | 84 | 0.020 | Female Segment Cavity Depth | 84 | 0.020 |
| Female Segment Thickness | 56 | 0.246 | Female Segment Thickness | 56 | 0.249 |
| Female Segment Length | 80 | 0.320 | Female Segment Length | 80 | 0.370 |

As stated, the foregoing Examples represent certain preferred embodiments of the invention, which have been shown to produce desired results. More specifically, the foregoing connectors and pipe assembly embodiments have been shown to resist certain bending moments and other stresses which are often experienced during, for example, HDD procedures. Accordingly, the foregoing. embodiments have been found to be useful in HDD methods and, more specifically, capable of sustaining such bending moments to allow the assembled pipe segments to change direction (i.e., bend, turn, etc.) during such HDD procedures. Those of ordinary skill in the art will appreciate that the foregoing embodiments are provided merely for illustration purposes, and that the pipe segment and connector dimensions may be adjusted as desired in accordance with the description above.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A pipe connecting assembly comprising:
a first connector comprising a plurality of engaging elements, a male segment, and a female segment; and
a second connector comprising a plurality of engaging elements which are complementary to the engaging elements of said first connector, a male segment, and a female segment, wherein the first connector and the second connector are each at least 4.5 inches in length.

2. The pipe connecting assembly of claim 1, wherein the first connector and the second connector are each at least 6.0 inches in length.

3. The pipe connecting assembly of claim 1, wherein the first connector and the second connector are each at least 8.0 inches in length.

4. The pipe connecting assembly of claim 1, wherein the first connector and the second connector are each at least 10.0 inches in length.

5. A pipe connecting assembly comprising:
a first connector comprising (i) a plurality of engaging elements, wherein the length of each engaging element is at least 0.60 inches, (ii) a male segment, and (iii) a female segment; and
a second connector comprising (i) a plurality of engaging elements, wherein the length of each engaging element is at least 0.60 inches and wherein the engaging elements of the second connector are complementary to the engaging elements of said first connector, (ii) a male segment, and (iii) a female segment, wherein the first connector and the second connector are each at least 4.5 inches in length.

6. The pipe connecting assembly of claim 5, wherein the length of each engaging element of the first connector and the second connector is greater than 0.80 inches.

7. The pipe connecting assembly of claim 6, wherein the first connector and the second connector are each at least 6.0 inches in length.

8. The pipe connecting assembly of claim 5, wherein the length of each engaging element of the first connector and second connector is greater than 1.00 inches.

9. The pipe connecting assembly of claim 8, wherein the first connector and the second connector are each at least 6.0 inches in length.

10. The pipe connecting assembly of claim 5, wherein the length of each engaging element of the first connector and the second connector is greater than 1.20 inches.

11. The pipe connecting assembly of claim 10, wherein the first connector and the second connector are each at least 6.0 inches in length.

12. A method of installing pipeline in a pilot hole, which comprises:
(a) placing a first connector of a first pipe segment in the proximity of a second connector of a second pipe segment, wherein (i) said first connector and said second connector each comprise a plurality of engaging elements, a male segment, and a female segment, (ii) the engaging elements, male segment, and female segment of said first connector are capable of interlocking with the engaging elements, male segment, and female segment of said second connector, and (iii) the first connector and the second connector are each at least 4.5 inches in length;
(b) attaching said first pipe segment to said second pipe segment by causing the engaging elements, male segment, and female segment of the first connector to interlock with the engaging elements, male segment, and female segment of the second connector; and
(c) applying sufficient force to the attached first and second pipe segments to advance the segments forward.

13. The method of claim 12, wherein the first connector and the second connector are each at least 6.0 inches in length.

14. The method of claim 12, wherein the first connector and the second connector are each at least 8.0 inches in length.

15. The method of claim 12, wherein the first connector and the second connector are each at least 10.0 inches in length.

16. The method of claim 12, wherein the length of each engaging element of the first connector and the second connector is greater than 0.80 inches.

17. The method of claim 12, wherein the length of each engaging element of the first connector and the second connector is greater than 1.00 inches.

18. The method of claim 12, wherein the length of each engaging element of the first connector and the second connector is greater than 1.20 inches.
